(19) United States
(12) Patent Application Publication
(10) Pub. No.: US 2012/0144222 A1
(43) Pub. Date: Jun. 7, 2012

(54) INFORMATION PROCESSING SYSTEM

(75) Inventor: Daisuke Ito, Kawasaki-shi (JP)

(73) Assignee: CANON KABUSHIKI KAISHA, Tokyo (JP)

(21) Appl. No.: 13/299,238

(22) Filed: Nov. 17, 2011

(30) Foreign Application Priority Data
Dec. 1, 2010 (JP) 2010-268748

(51) Int. Cl. G06F 1/26

(52) U.S. Cl. 713/340

(57) ABSTRACT

An information processing system including a Web server and an information processing apparatus with a Web browser stores information indicative of a power consumed in execution of a function with respect to each of functions, wherein the information processing apparatus sets an upper limit of a power consumed by executing at least any one of the functions, determines whether or not the power consumed by the execution of the function exceeds the power set by a setting unit with respect to each of functions, and performs control such that a function determined as consuming the power beyond the set power is not executed.

### BACKGROUND OF THE INVENTION

1. Field of the Invention

Embodiments of the present invention relate to an information processing system.

2. Description of the Related Art

Conventionally, a technique is known in which an information processing apparatus connected to a Web server on a network causes a Web browser included in the information processing apparatus to display an operation screen based on screen information provided by the Web server.

Japanese Patent Laid-open Publication No. 2006-127503 discusses a system in which an information processing apparatus receives an operation screen for requesting an executive instruction of an application running on the Web server and the operation screen is displayed. The information processing apparatus obtains an input by an operator into the operation screen to transmit it to the Web server. The Web server executes an application in response to the input by the user. The Web server transmits data processed and obtained by the execution of the application, to the information processing apparatus. The information processing apparatus executes its specific function by using the data having been processed.

According to Japanese Patent Laid-open Publication No. 2006-127503, the information processing apparatus may display the operation screen when it obtains screen information for displaying the operation screen from the Web server even if the information processing apparatus does not preliminarily store the operation screen for executing its own specific function. The Web server changes the screen information stored by the Web server in a case where the function specific to the information processing apparatus is changed, so that proper screen information according to the function of the information processing apparatus may be provided to the information processing apparatus after the change of the screen information.

In the information processing system including the information processing apparatus and the Web server as discussed in Japanese Patent Laid-open Publication No. 2006-127503, there is a demand that a power consumed by the whole system should be controlled to be under a certain upper limit. In the information processing system, a power consumption according to the specific function executed by the information processing apparatus accounts for a high percentage in the entire power consumption of the information processing apparatus. Accordingly, an execution of the specific function may cause the power to exceed the upper limit of the power consumption.

### SUMMARY OF THE INVENTION

One disclosed aspect of the embodiments is directed to an information processing system including a Web server and an information processing apparatus with a Web browser for displaying an operation screen based on screen information provided by the Web server. The information processing apparatus executes control to set an upper limit of a power to be consumed when at least any one of functions is carried out, and suitably controls the information processing apparatus so as not to execute a function that consumes a power beyond the set power.

According to an aspect of the embodiments, an information processing system including a Web server and an information processing apparatus with a Web browser for displaying a screen based on screen information transmitted from the Web server, wherein the information processing apparatus includes a first requesting unit configured to request a transmission of the screen information for allowing the Web browser to display a screen, to the Web server, a first receiving unit configured to receive the screen information transmitted from the Web server in response to the request of the first requesting unit, a Web browser configured to display the screen based on the screen information received by the first receiving unit, a reception unit configured to receive a request of the executive instruction input from an operator of the information processing apparatus via the area, in a case where an area for requesting to the Web server an executive instruction of an Web application related to at least any one of functions executable by the information processing apparatus is included in the screen displayed by the Web browser, a second requesting unit configured to request the executive instruction of the Web application to the Web server, in a case where the reception unit receives the request of the executive instruction, and an execution unit configured to execute the function in response to the reception of the executive instruction of the function related to the Web application from the Web server, wherein the Web server includes a first transmission unit configured to transmit, in a case where a transmission of the screen information is requested by the first requesting unit, the screen information to the information processing apparatus, and a second transmission unit configured to transmit the executive instruction of the function related to the Web application corresponding to the request to the information processing apparatus in a case where the executive instruction of the Web application is requested by the second requesting unit, and wherein the information processing system further includes a storage unit configured to store information indicative of a power consumed when executing the function with respect to each of the functions, a setting unit configured to set an upper limit of the power consumed when executing at least any one of the functions by the information processing apparatus, a determination unit configured to determine whether or not the power consumed by the execution of the function exceeds the power set by the setting unit with respect to each of the functions based on the information stored in the storage unit, and a control unit configured to perform control such that the function determined by the determination unit as consuming the power beyond the power set by the setting unit is not executed by the execution unit.

Further features and aspects of the embodiments will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the embodiments.

FIG. 1 illustrates an entire view of an information processing system in a first exemplary embodiment.

FIG. 2 is a block diagram illustrating a device configuration of a multifunction peripheral (MFP).

FIG. 3 illustrates a device configuration of a Web server.

FIG. 4 illustrates a software configuration of an information processing system.

FIG. 5 illustrates a power management table.

FIG. 6 illustrates a table including a description of information indicative of an upper limit of a power consumption of the MFP.

FIG. 7 is a flow chart illustrating processing operations performed by the MFP and the Web server, respectively.

FIG. 8 illustrates screen information (i.e., Hypertext Markup Language (HTML) file).

FIG. 9 illustrates a screen that the Web browser causes an operation unit to display.

FIG. 10 illustrates another screen that the Web browser causes the operation unit to display.

FIG. 11 is another flowchart illustrating processing operations performed by the MFP and the Web server, respectively.

FIG. 12 illustrates another screen information (i.e., HTML file).

FIG. 13 is another flowchart illustrating processing operations performed by the MFP and the Web server, respectively.

### DESCRIPTION OF THE EMBODIMENTS

Various exemplary embodiments, features, and aspects of the embodiments will be described in detail below with reference to the drawings. One disclosed feature of the embodiments may be described as a process which is usually depicted as a flowchart, a flow diagram, a timing diagram, a structure diagram, or a block diagram. Although a flowchart or a timing diagram may describe the operations or events as a sequential process, the operations may be performed, or the events may occur, in parallel or concurrently. In addition, the order of the operations or events may be re-arranged. A process is terminated when its operations are completed. A process may correspond to a method, a program, a procedure, a method of manufacturing or fabrication, a sequence of operations performed by an apparatus, a machine, or a logic circuit, etc.

The same components are provided with like reference numbers or symbols and definitions thereof are made once. Initially, a configuration block necessary for the present exemplary embodiment will be described and subsequently processing will be described in detail.

A first exemplary embodiment is described below. In the first exemplary embodiment, the Multi Function Peripheral (MFP) as an information processing apparatus requests screen information for displaying an operation screen to be displayed on the Web browser of the MFP, to the Web server on a network. The Web server having received the request generates screen information to transmit it to the MFP. The MFP having received the screen information displays the operation screen on the Web browser according to the screen information.

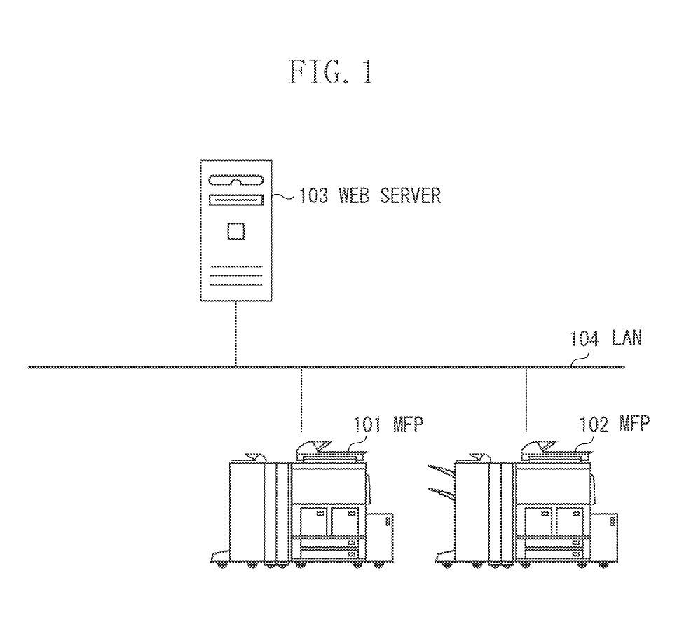

FIG. 1 illustrates an entire view of an information processing system in the first exemplary embodiment. The information processing system includes a Web server 103, a MFP 101, and a MFP 102, which are communicable to each other via a Local Area Network (LAN) 104. The MFP 101, the MFP 102, and the Web server 103 may be connected each other via an internet, a radio communication, and the other connecting method in addition to the LAN.

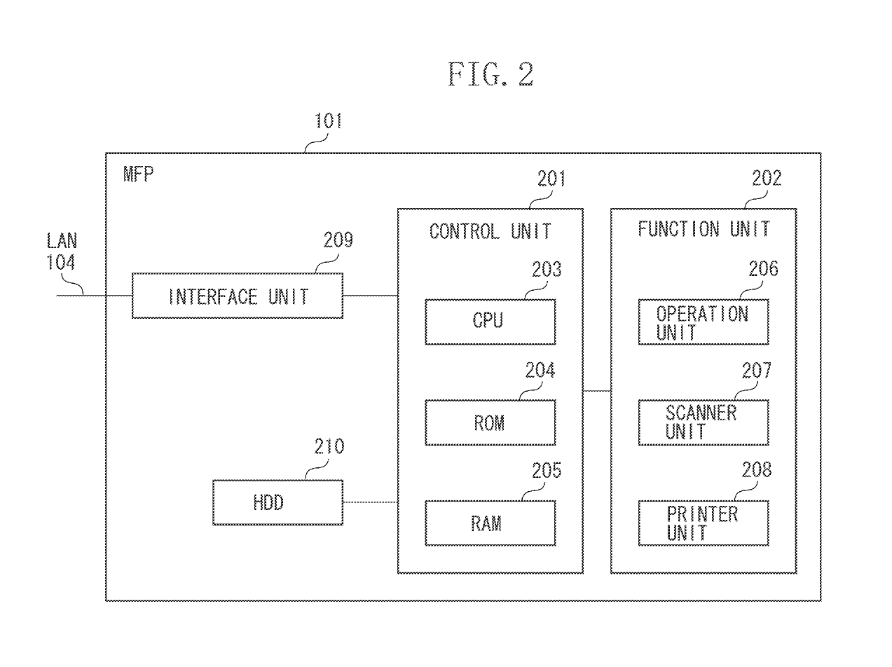

FIG. 2 is a block diagram illustrating a device configuration of the MFP 101. A control unit 201 including a central processing unit (CPU) 203 controls an operation of the whole MFP 101. The CPU 203 reads out control programs stored in a Read Only Memory (ROM) 204 and a hard disk drive (HDD) 210 and controls data writing and data reading to and from the RAM 205 and the HDD 210. The CPU 203 controls each of an operation unit 206, a scanner unit 207, and a printer unit 208 included in the below described function unit 202. The ROM 204 stores a control program for executing processing in each flow chart described below. The RAM 205 is used as a temporary storage area such as a main memory, a work area, or the like of the CPU 203.

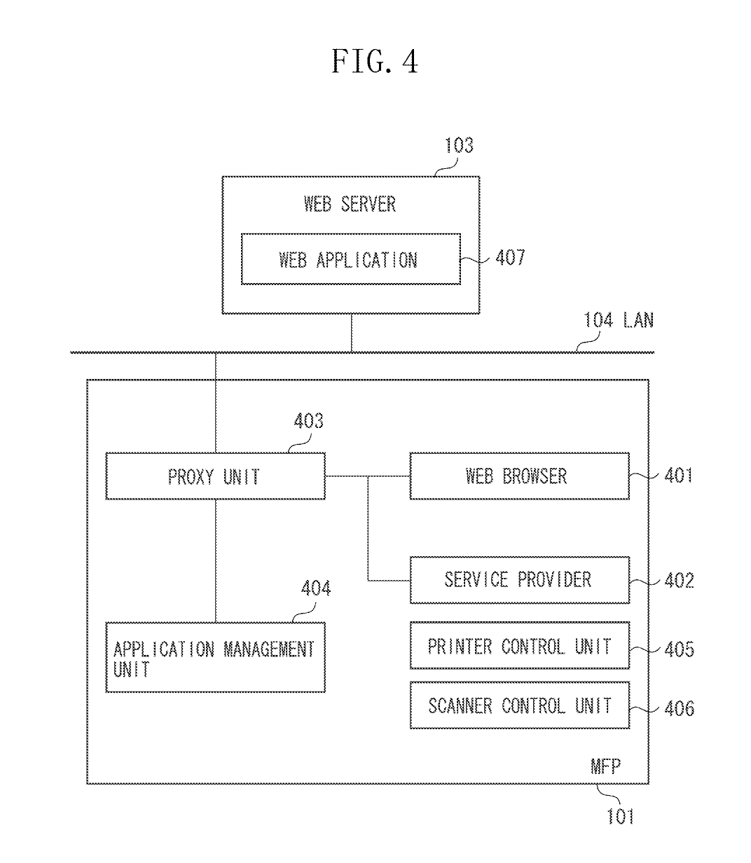

A function unit 202 includes an operation unit 206, a scanner unit 207, and a printer unit 208. The operation unit 206 includes a liquid crystal display unit having a keyboard function and a touch panel function. The operation unit 206 displays an operation screen that is displayed by the Web browser which is software executed by the CPU 203. More specifically, a Web browser 401 of the MFP 101 illustrated in the below described FIG. 4 analyzes a Hyper Text Markup Language (HTML) file as screen information received from the Web server 103. The Web browser 401 displays an operation screen based on a description of the analyzed HTML file on the operation unit 206.

The scanner unit 207 reads out a document placed on a platen (not illustrated), generates image data, and inputs the generated image data into the control unit 201 in image reading processing. In a case where the scanner unit 207 executes the image reading processing, the control unit 201 causes the HDD 210 to store the image data input by the scanner unit 207 via the RAM 205.

A printer unit 208 executes print processing to print the image data stored in the HDD 210 on a recording medium such as a paper.

An interface unit 209 is connected to the LAN 104 and receives the image data and the image information (i.e., HTML file) for displaying the operation screen on the operation unit 206, from the Web server 103 via the LAN 104. The CPU 203 causes the RAM 205 and the HDD 210 to store the screen information received by the interface unit 209.

A device configuration of the MFP 102 is identical to a device configuration of the MFP 101. However, for example, the MFP 102 may include the scanner unit 207 but may not include the printer unit 208. Further, for example, the MFP 102 may include the printer unit 208 but may not include the scanner unit 207.

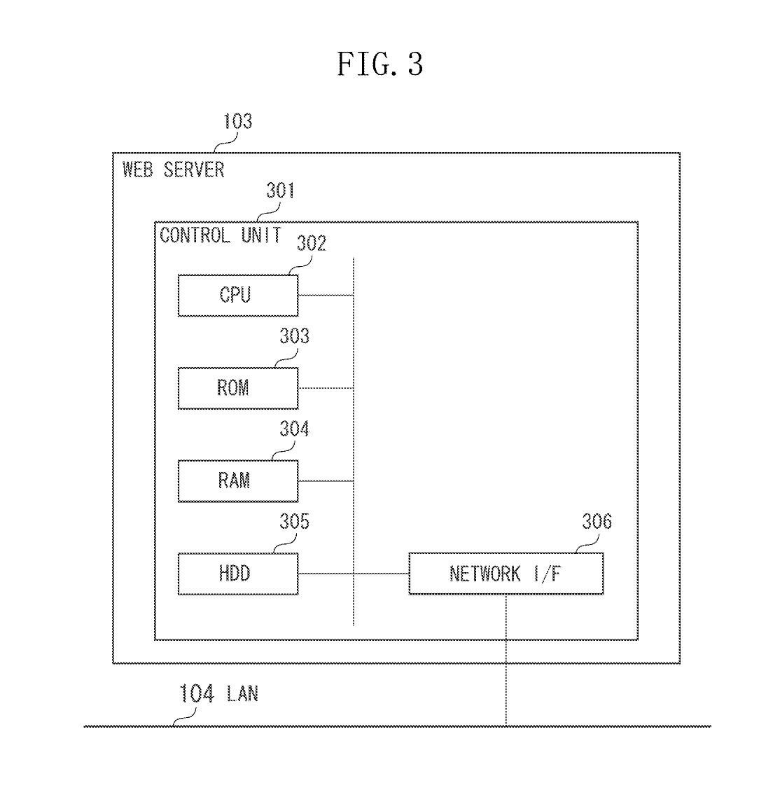

FIG. 3 is a block diagram illustrating a device configuration of the Web server 103. A control unit 301 including a CPU 302 controls an operation of the whole Web server 103. The CPU 302 reads out control programs stored in a ROM 303 and a HDD 305 to control data writing and data reading to and from the RAM 304 and the HDD 305. The CPU 302 executes various processing including execution of the below described application program. The RAM 304 is used as a temporary storage area such as a main memory and a work area of the CPU 302. A network I/F 306 connects the control unit 301 to the LAN 104. The HDD 305 stores the control program and various Web applications.

FIG. 4 illustrates a software configuration of the information processing system. Various functions executed by the software configuration illustrated in FIG. 4 are realized by the CPU included in each of the MFP 101 and the Web server 103 illustrated in FIG. 2 and FIG. 3 which executes the control program.

In FIG. 4, the MFP 101 includes a Web browser 401, a service provider 402, a proxy unit 403, an application management unit 404, a printer control unit 405, and a scanner control unit 406.

The Web browser 401 requests the Web server 103 to transmit screen information for allowing the Web browser 401 to cause the operation unit 206 to display an operation screen. The Web browser 401 communicates with the Web server 103 via the interface 104 and the network I/F 306. The communication between the Web browser 401 and the Web server 103 is realized via the proxy unit 403. More specifically, the Web browser 401 requests the operation screen of the MFP 101 displayed by the operation unit 206 to the proxy server 403 and notifies an instruction from the user input via the operation screen displayed by the operation unit 206 of the MFP 101 to the proxy unit 403.

The service provider 402 opens functions executable by the MFP 101 on the Web server 103 on the network. An example of the functions to be opened includes a function of causing the scanner unit 207 to read a document to generate image data and causing the HDD 210 to store the generated image data by the CPU 203 activating the scanner control unit 406 (i.e., image reading function). Further, another example of the functions to be opened includes a function of printing image data stored in the HDD 210 onto a sheet using the printer unit 208 by the CPU 203 activating the printer control unit 405 (i.e., print function). Another example of the functions to be opened includes a function of causing the scanner unit 207 to read a document to generate image data by the CPU 203 activating the scanner control unit 406 and the printer control unit 405, and printing the generated image data onto a sheet by activating the printer control unit 405 (i.e., reproducing function). In the reproducing function, the image data generated by the scanner unit 207 is temporarily stored in the HDD 210 and subsequently printed by using the printer unit 208.

The proxy unit 403 receives a response from the Web server 103 with respect to the request to the Web server 103 and transmits the response to the Web browser 401 and the service provider 402 after changing contents of the response as required.

The application management unit 404 manages a plurality of applications installed in the MFP 101. For example, the application management unit 404 notifies a state of an installation of the application to the proxy unit 403 in response to a request from the proxy unit 403 and executes the application which is requested from the proxy unit 403.

The printer control unit 405 and the scanner control unit 406 control the printer unit 208 and the scanner unit 207, respectively, included in the MFP 101.

The Web server 103 includes a Web application 407. The Web application 407 is the various Web applications included in the Web server 103 and is executed in response to the execution request of the Web application received via the proxy unit 403 from the Web browser 401.

The Web applications 407 in the present exemplary embodiment include an image reading application for executing the image reading function, a print application for executing the print function, and a reproduction application for executing the reproducing function.

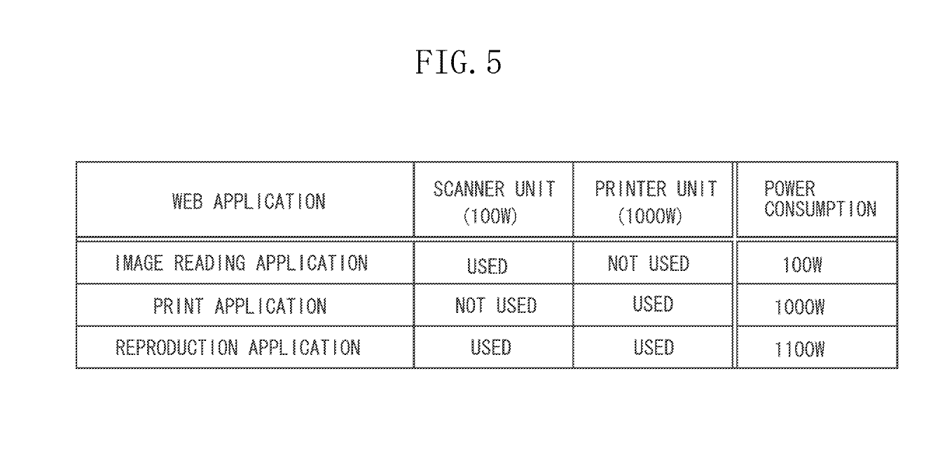

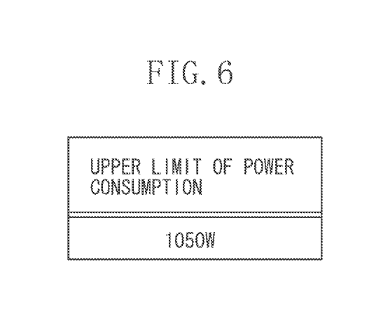

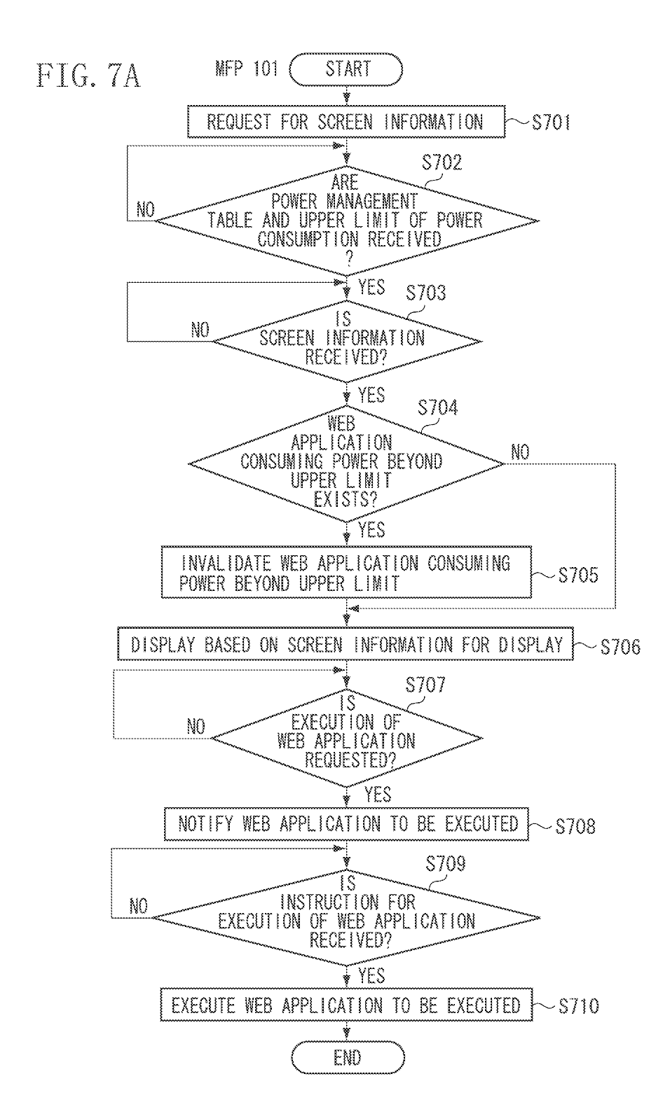

The HDD 305 of the Web server 103 stores tables illustrated in FIGS. 5 and 6. Each of the Web applications may refer to the tables of FIGS. 5 and 6.

FIG. 5 is a power management table stored in the HDD 305 of the Web server 103. The power management table includes descriptions of types of Web applications and information indicating whether or not the scanner unit 207 and the printer unit 208 of the MFP 101 are used in the execution of each Web application. The power management table of FIG. 5 includes information indicative of a power consumed by the MFP 101 in the execution of each Web application.

FIG. 6 is a table including a description of information indicative of an upper limit of the power consumed by the MFP 101. The Web server 103 notifies the upper limits of the power consumed by the Web application having received the execution request (FIG. 5) and the power consumed by the MFP 101 (FIG. 6), to the MFP 101 in a case where the execution of the Web application is requested from the MFP 101. As illustrated in FIG. 5, the power consumption of the image reading application is 100 W, the power consumption of the print application is 1000 W, and the power consumption of the reproduction application is 1100 W, respectively.

The upper limit of the power consumption illustrated in FIG. 6 is a value set by the Web server 103. The value may be varied when the Web server 103 rewrites the power management table stored in the HDD 305. The Web server 103 manages an execution state of the Web application requested from the MFP 101 and varies the upper limit of the power consumption of FIG. 6 according to the execution state of the Web application. The Web server 103 sets, for example, a target value of the amount of power to be consumed in a day, and changes the upper limit of the power consumption to a higher value or a lower value according to an actually consumed amount of power up to the current time with respect to the target value. As illustrated in FIG. 6, a reason why the target value of the power consumption is set to 1050 W is to prohibit the execution of the reproduction application in order to prevent the reproduction application from consuming the power. In a case where an actually consumed amount of power up to the current time is smaller enough than the target value of the amount of power to be consumed in a day, the target value of the power consumption is set to a value equal to or more than 1100 W. Accordingly, the Web server 103 allows the execution of the reproduction application.

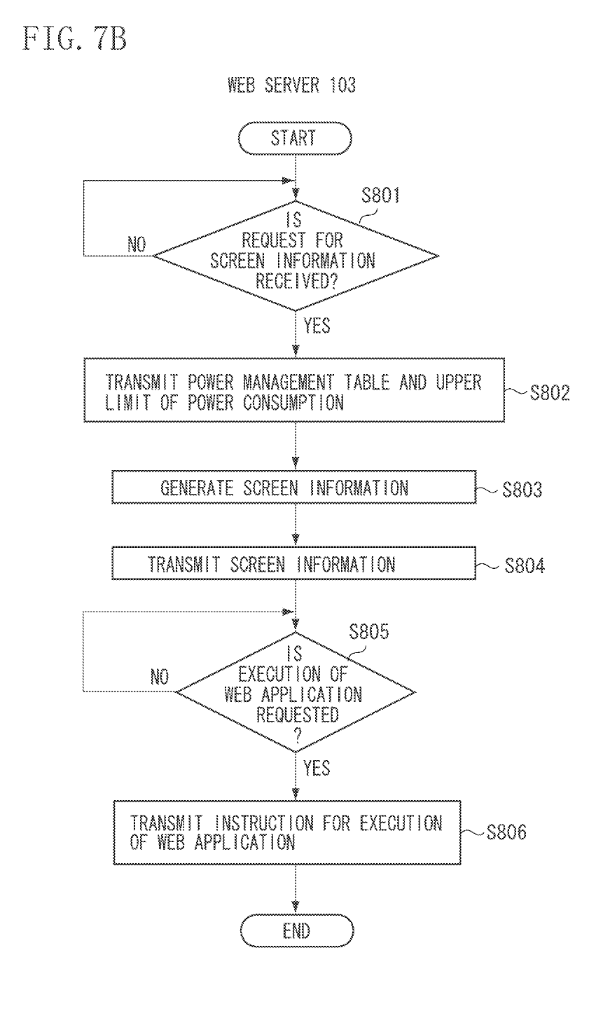

Now, the processing performed when the MFP 101 requests screen information to the Web server 103 and displays the operation screen based on the screen information transmitted from the Web server in response to a request, is described below with reference to a flow chart of FIG. 7. In operations S701 through S710 in FIG. 7, the CPU 203 of the MFP 101 develops the programs stored in the ROM 204 and the HDD 210, on the RAM 205 to execute the programs thereon. In operations S801 through S806 in FIG. 7, the CPU 302 of the Web server 103 develops the programs stored in the ROM 303 and the HDD 305, on the RAM 304 to execute the programs thereon.

In operation operation S701, the MFP 101 transmits to the Web server 103 a request to cause the operation unit 206 to transmit the screen information for displaying the screen to the MFP 101 (i.e., first request). The request for the screen information is made when the MFP 101 is turned on or when shifting to a screen for executing the Web application is instructed by the operation of the user to the operation unit 206. The request is transmitted to the Web server 103 from the interface unit 209 via the LAN 104.

In operation S801, the Web server 103 (i.e., first receiving unit) determines whether or not the transmission request of the screen information is received from the MFP 101. In a case where the Web server 103 determines that the transmission request is received (YES in operation S801), the processing proceeds to operation 5802.

In operation S802, the Web server 103 transmits information described in the power management table of FIG. 5 and the upper limit of the power consumption of FIG. 6 to the MFP 101.

In operation S803, the Web server 103 (i.e., first transmission unit) generates screen information. In operation S804, the Web server 103 transmits thus generated screen information to the MFP 101.

In operation S702, the MFP 101 determines whether or not MFP 101 has received the information described in the power management table and the upper limit of the power consumption from the Web server 103 via the interface unit 209. In a case where the MFP 101 determines that the MFP 101 has received the information (YES in operation S702), the processing proceeds to operation S703.

In operation S703, the MFP 101 determines whether or not the MFP 101 has received the screen information from the Web server 103 via the interface unit 209. In a case where the MFP 101 determines that the MFP 101 has received the screen information (YES in operation S703), the processing proceeds to operation S704.

In operation S704, the MFP 101 determines whether or not a Web application consuming the power beyond the upper limit of the power consumption exists based on the information described in the power management table and the upper limit of the power consumption. In FIG. 5, the power consumption of the image reading application is 100 W, the power consumption of the print application is 1000 W, and the power consumption of the reproduction application is 1100 W. In FIG. 6, the upper limit of the power consumption is 1050 W. In this case, the MFP 101 determines that the reproduction application (1100 W) exists as the Web application that consumes the power beyond the upper limit of the power consumption, i.e., 1050 W (YES in operation S704).

In operation S705, the MFP 101 invalidates the Web application determined as consuming the power beyond the upper limit of the power consumption so that the Web application determined as consuming the power beyond the upper limit of the power consumption in operation S704 is not executed.

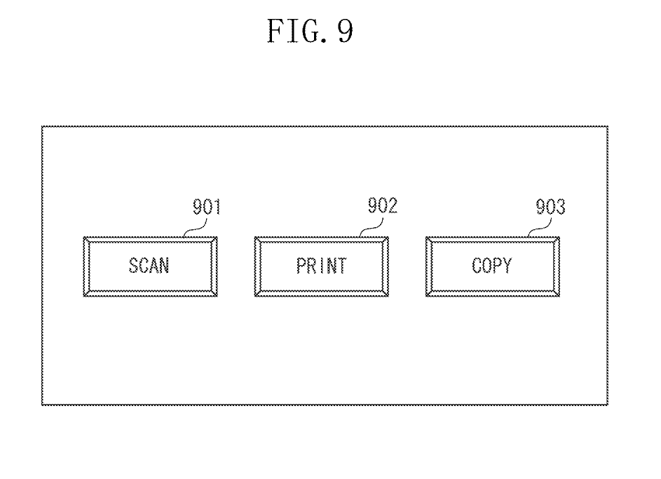

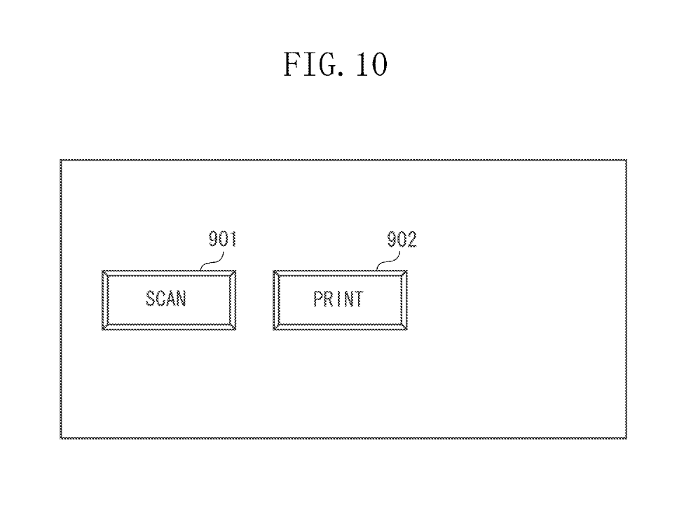

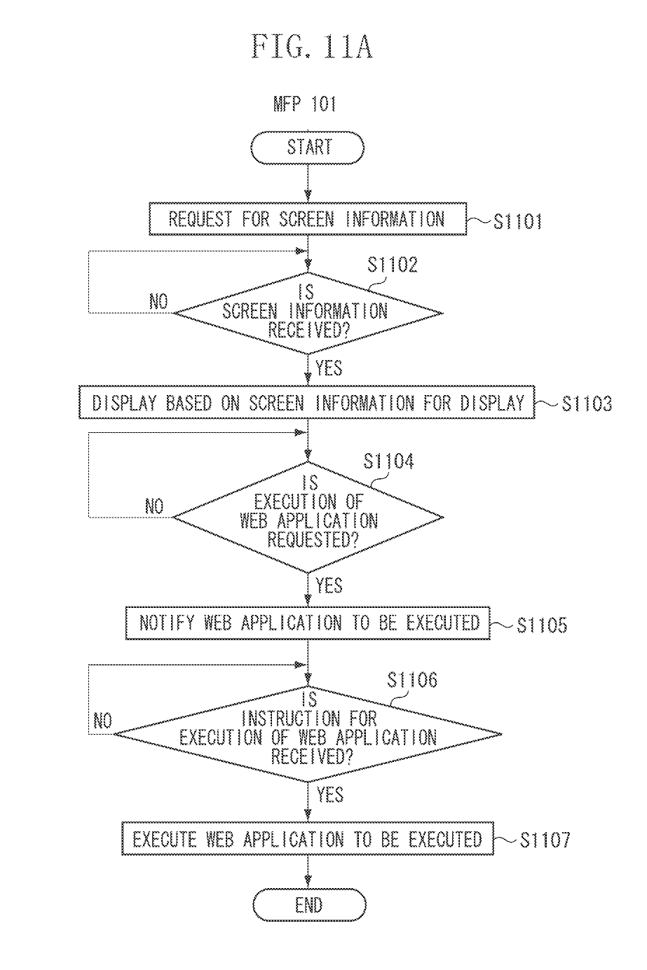

In operation S706, the Web browser 401 of the MFP 101 causes the operation unit 206 to display a screen exemplified in FIG. 9 or FIG. 10 based on the screen information received in operation S703.

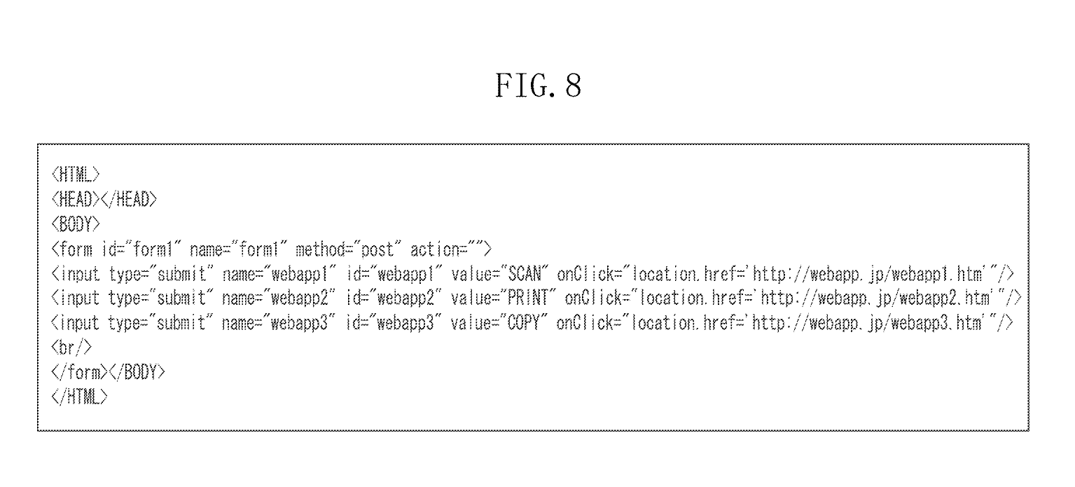

Screen information generated by the Web server 103 in operation S803 and the screen displayed on the operation unit 206 of the MFP 101 in operation S703 are described with reference to FIGS. 8 through 10.

FIG. 8 is a Hyper Text Markup Language (HTML) file which is the screen information generated by the Web server 103. Three components indicated by an <INPUT> tag in the HTML file are information for displaying buttons for executing three different types of Web applications managed by the Web application 407 on the operation panel 206 of the MFP 101. Each button is displayed on the screen as an area for requesting the executive instruction related to each button, to the Web server 103.

FIG. 9 illustrates a screen that is displayed on the operation unit 206 by the Web browser 401 of the MFP 101 after the MFP 101 receives the HTML file of FIG. 8. On a button 901 of FIG. 9, a character string “scan” corresponding to a value within the <INPUT> tag is displayed. On a button 902 of FIG. 9, a character string “print” corresponding to a value within the <INPUT> tag is displayed. On a button 903 of FIG. 9, a character string “copy” corresponding to a value within the <INPUT> is displayed.

In operation S704, in a case where the MFP 101 determines that a Web application consuming the power beyond the upper limit of the power consumption does not exist (NO in operation S704), any one of the 3 Web applications is not invalidated. Therefore, in this case, the Web browser 401 causes the operation unit 206 to display the screen illustrated in FIG. 9 based on the screen information illustrated in FIG. 8.

On the other hand, in operation S704, in a case where the MFP 101 determines that a Web application consuming the power beyond the upper limit of the power consumption exists (YES in operation S704), the Web application determined as consuming the power beyond the upper limit of the power consumption is invalidated. For example, in a case where the MFP 101 determines that the reproduction application consumes the power beyond the upper limit of the power consumption, the CPU 302 of the Web server 103 controls the Web browser 401 not to display the button corresponding to the reproduction application included in the screen information of FIG. 8. The Web browser 401 causes the operation unit 206 to display a screen illustrated in FIG. 10.

As described above, the Web browser 401 causes the operation unit 206 to display the screen based on the screen information illustrated in FIG. 8.

An operation performed in a case where the execution of the Web application is instructed via the screen displayed on the operation unit 206 is described below.

In operation S707, the MFP 101 determines whether or not an execution request of the Web application is made via a screen displayed on the operation unit 206. In a case where the MFP 101 determines that the execution request is made (YES in operation S707), the processing proceeds to operation S708.

The operation unit 206 is of a touch panel type The MFP 101 may recognize that portions corresponding to the buttons 901, 902, and 903 are pressed by the user of the MFP 101. In a case where the MFP 101 recognizes that the portion corresponding to the button 901 is pressed by the user, the MFP 101 determines that the execution request of the image reading application is made. In a case where the MFP 101 recognizes that the portion corresponding to the button 902 is pressed by the user, the MFP 101 determines that the execution request of the print application is made. In a case where the MFP 101 recognizes that the portion corresponding to the button 903 is pressed by the user, the MFP 101 determines that the execution request of the reproduction application is made.

In operation S708, the MFP 101 notifies the Web application about which the execution request is made in operation S707, to the Web server 103 via the interface unit 209. In a case where the MFP 101 (i.e., second requesting unit) determines that the execution request of the image reading application is made, the MFP 101 notifies that execution of the image reading application is instructed. In a case where the MFP 101 determines that the execution request of the print application is made, the MFP 101 notifies that execution of the print application is instructed. In a case where the MFP 101 determines that the execution request of the reproduction application is made, the MFP 101 notifies that the execution of the reproduction application is instructed.

The notification is made when the Web browser 401 executed by the MFP 101 gets access to a URL corresponding to the Web application having received the execution request. As illustrated in FIG. 8, the <INPUT> tag of the HTML file includes a description of the URL to be accessed by the Web browser 401 of the MFP 101 when each button is clicked. In a case where the button 901 is clicked (accepted) by an operation of the user (i.e., operator) of the MFP 101, the Web browser 401 gets access to http://webapp.jp/webbapp1.htm as the URL within the Web server 103. In a case where the button 902 is clicked by the operation of the user of the MFP 101, the Web browser 401 gets access to http://webapp.jp/webbapp2.htm as the URL within the Web server 103. In a case where the button 903 is clicked by the operation of the user of the MFP 101, the Web browser 401 gets access to http://webapp.jp/webbapp3.htm as the URL within the Web server 103.

In other words, when the Web browser 401 gets access to http://webapp.jp/webbapp1.htm, it is notified that the execution request of the image reading application is made. When the Web browser 401 gets access to http://webapp.jp/webbapp2.htm, it is notified that the execution request of the print application is made. When the Web browser 401 gets access to http://webapp.jp/webbapp3.htm, it is notified that the execution request of the reproduction application is made.

Processing in a case where the Web server 103 receives the execution request of the Web application from the MFP 101 is described below.

In operation S805, the Web server 103 determines whether or not the Web server 103 has received the execution request of the Web application from the MFP 101. In a case where the Web server 103 determines that the execution request is received (YES in operation S805), the processing proceeds to operation S806. The Web server 103 determines the URL which is accessed from the MFP 101, so that the Web application having received the execution request may be recognized. More specifically, in a case where the access is obtained with respect to http://webapp.jp/webbapp1.htm, the Web server 103 recognizes that the execution request of the image reading application is made. In a case where the access is obtained with respective to http://webapp.jp/webbapp2.htm, the Web server 103 recognizes that the execution request of the print application is made. In a case where the access is obtained with respect to http://webapp.jp/webbapp3.htm, the Web server 103 recognizes that the execution request of the reproduction application is made.

In operation S806, the Web server 103 (i.e., second transmission unit) transmits the executive instruction of the Web application having received the execution request in operation S805, to the MFP 101. More specifically, in a case where the execution request of the image reading application is made, the Web server 103 transmits the executive instruction of the image reading application to the MFP 101. In a case where the execution request of the print application is made, the Web server 103 transmits the executive instruction of the print application to the MFP 101. Alternatively, in a case where the execution request of the reproduction application is made, the Web server 103 transmits the execution request of the reproduction application to the MFP 101.

Processing executed by the MFP 101 after receiving the executive instruction of the Web application from the Web server 103 is described below.

In operation S709, the MFP 101 determines whether or not the MFP 101 has received the executive instruction of the Web application transmitted from the Web server 103. In a case where the MFP 101 determines that the executive instruction is received (YES in operation S709), the processing proceeds to operation S710. In operation S709, the MFP 101 receives any one of the executive instruction of the image reading application, the executive instruction of the print application, or the executive instruction of the reproduction application.

In operation S710, the MFP 101 executes the Web application having received the executive instruction in operation S709. In a case where the executive instruction of the image reading application is made, the MFP 101 reads out a document by the scanner unit 207 to generate image data and causes the HDD 210 to store the generated image data. In a case where the executive instruction of the print application is made, the MFP 101 causes the printer unit 208 to print the image data stored in the HDD 210. In a case where the executive instruction of the reproduction application is made, the MFP 101 reads out a document by the scanner unit 207 to generate image data and causes the printer unit 208 to print the generated image data. When the MFP 101 executes the reproduction application, the image data generated by the scanner unit 207 is temporarily stored in the HDD 210. Subsequently, the image data stored in the HDD 210 is printed by the printer unit 208.

As described above, the information processing system includes the Web server 103 and the MFP 101 with the Web browser 401 for displaying the screen based on the screen information provided by the Web server 103 according to the first exemplary embodiment. The information processing system may set the upper limit of the power consumed when the MFP 101 executes at least any one of functions and suitably perform control such that the MFP 101 does not execute the function that consumes the power beyond the set power.

In the above description, the button to be displayed on the operation unit 206 is not displayed so that the function corresponding to the Web application consuming the power beyond the upper limit of the power consumption is not executed but another configuration may also be employed. For example, the screen displayed on the operation unit 206 may always be the one as illustrated in FIG. 9 regardless of a value of the upper limit of the power consumption. In this case, if the user presses the button corresponding to the Web application consuming the power beyond the upper limit of the power consumption, the CPU 302 of the Web server 103 controls the Web browser 401 or the proxy unit 403 not to transmit the execution request for executing the function corresponding to the button, to the Web server 103. Accordingly, control may be performed such that the function corresponding to the Web application consuming the power beyond the upper limit of the power consumption is not executed.

In the above description, the Web server 103 manages the power management table and the upper limit of the power consumption but a device other than the Web server 103 may manage them. In this case, the processing in operation S802 of FIG. 7 may be executed by a device other than the Web server 103.

In the above description, in a case where the MFP 101 requests the screen information in operation S701, the power management table and the upper limit of the power consumption are transmitted to the MFP 101 from the Web server 103 but another configuration may also be employed. For example, according to change of the upper limit of the power consumption by the Web server 103, the power management table and the upper limit of the power consumption may be transmitted to the MFP 101 from the Web server 103. In this case, the MFP 101 executes the processing from operations S704 through S706 of FIG. 7 according to the reception of the upper limit of the power consumption. Accordingly, a suitable control is achieved such that the function consuming the power beyond the changed upper limit of the power consumption is not executed by the MFP 101 according to the change of the upper limit of the power consumption.

A second exemplary embodiment as a modified example of the first exemplary embodiment is described below.

In the first exemplary embodiment, the MFP 101 controls the Web browser 401 and the proxy unit 403 such that the MFP 101 does not execute the function corresponding to the Web application consuming the power beyond the upper limit of the power consumption.

To the contrary, in the second exemplary embodiment, the Web server 103 changes the screen information so that the MFP 101 does not execute the function corresponding to the Web application consuming the power beyond the upper limit of the power consumption.

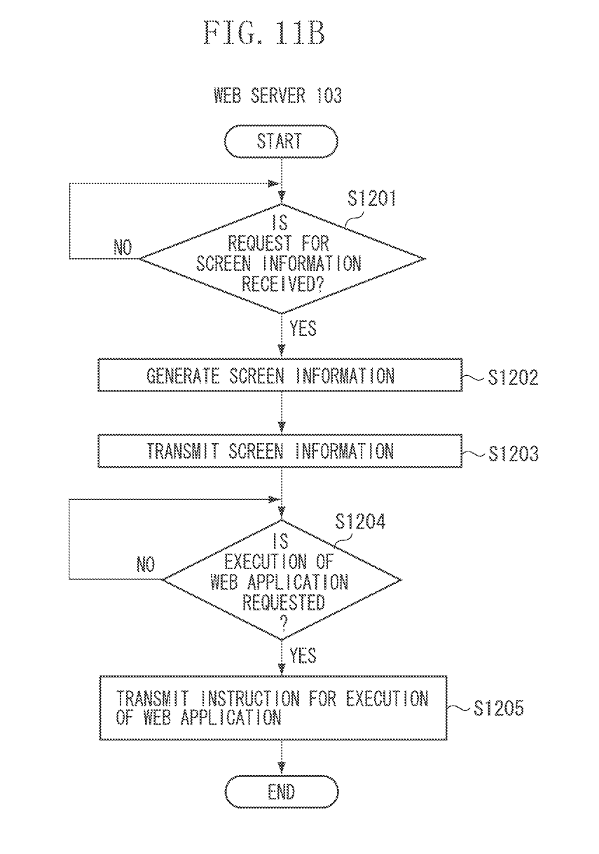

Processing operations when the MFP 101 requests the screen information to the Web server 103 and displays the operation screen based on the screen information transmitted from the Web server 103 in response to the request are described below by using a flowchart of FIG. 11. Operations S1101 through 1107 in FIG. 11 are processing in which the CPU 203 of the MFP 101 develops the programs stored in the ROM 204 and the HDD 210 on the RAM 205 to execute the programs thereon. Operations 1201 through 1205 in FIG. 11 are processing in which the CPU 302 of the Web server 103 develops the programs stored in the ROM 303 and the HDD 305 on the RAM 304 to execute the programs thereon.

Processing performed in each of the operations S1101, S1102, and S1103 through 51107 of FIG. 11 is identical to the processing performed in each of the operations S701, S703 and S706 through S710 in the first exemplary embodiment, so that a description thereof is omitted here. Processing executed by the MFP 101 in the second exemplary embodiment differs from the processing executed by the MFP 101 in the first exemplary embodiment in that the processing executed by the operations S702, S704, and S705 is not included.

Processing performed in each of the operations S1201 and S1203 through S1205 of FIG. 11 is identical to the processing performed in each of the operations S801, and S804 through S806 in the first exemplary embodiment, so that a description thereof is omitted here. Processing executed by the Web server 103 in the second exemplary embodiment differs from the processing executed by the Web server 103 in the first exemplary embodiment in that the processing performed in operation S802 is not included. Processing executed in operation S1202 by the Web server 103 in the second exemplary embodiment differs from the processing performed in operation S803 by the Web server 103 in the first exemplary embodiment in that contents of the processing are different.

Processing that the Web server 103 executes in operation S1202 is described below.

In operation S1202, the Web server 103 generates screen information. However, the Web server 103 determines whether or not a Web application consuming the power beyond the upper limit of the power consumption exists based on the information described in the power management table of FIG. 5 and the upper limit of the power consumption of FIG. 6, prior to the generation of the screen information. In FIG. 5, the power consumption of the image reading application is 100 W, the power consumption of the print application is 1000 W, and the power consumption of the reproduction application is 1100 W. In FIG. 6, the upper limit of the power consumption is 1050 W. In this case, the Web server 103 determines that the reproduction application (1100 W) exists as the Web application consuming the power beyond the upper limit of the power consumption, i.e., 1050 W. The Web server 103 generates screen information indicating that the Web application determined as consuming the power beyond the upper limit of the power consumption is invalidated so that the Web application determined as consuming the power beyond the upper limit of the power consumption is not executed. In a case where the Web server 103 determines that the Web application consuming the power beyond the upper limit of the power consumption does not exist, the Web server 103 generates screen information indicating that all the Web applications executable by the Web server 103 are validated.

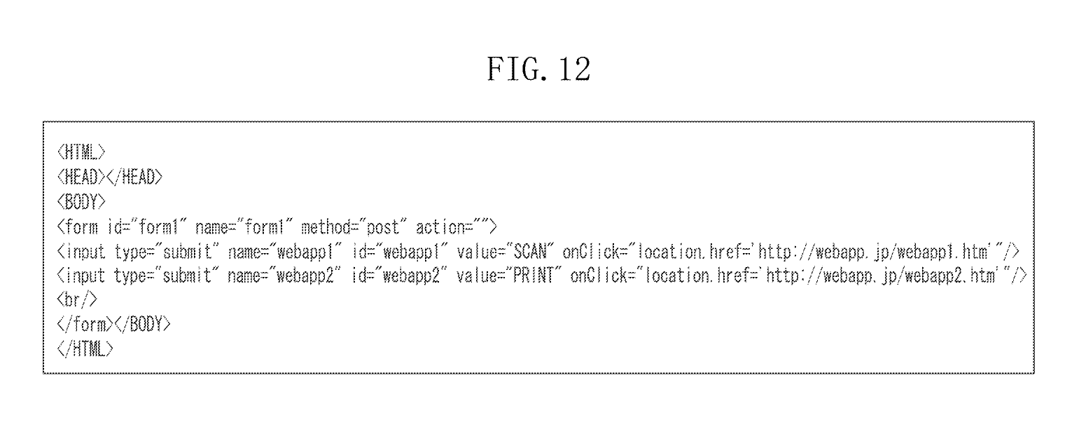

The screen information indicating that all the Web applications executable by the Web server 103 are validated is illustrated in FIG. 8. On the other hand, in a case where the Web server 103 determines that the reproduction application consumes the power beyond the upper limit of the power consumption, the screen information indicative of invalidation of the reproduction application is displayed as illustrated in FIG. 12. In operation S1103, the Web browser 401 of the MFP 101 having received the screen information illustrated in FIG. 8 displays a screen illustrated in FIG. 9 on the operation unit 206. In operation S1103, the Web browser 401 of the MFP 101 having received the screen information illustrated in FIG. 12 displays a screen illustrated in FIG. 10 on the operation unit 206.

As described above, the CPU 302 of the Web server 103 generates screen information, which excludes a button (i.e., area) for requesting the executive instruction of the Web application related to the function of consuming the power beyond the set upper limit. The screen information includes a button (i.e., area) for requesting the executive instruction of the Web application related to the function of not consuming the power beyond the set upper limit.

As described above, the second exemplary embodiment provides the information processing system including the Web server 103 and the MFP 101 with the Web browser 401 for displaying the screen based on the screen information provided by the Web server 103, wherein the MFP 101 may set the upper limit of the power consumed by the execution of any one of functions and may be suitably controlled not to execute the function consuming the power beyond the set power.

In the above description, the power management table and the upper limit of the power consumption are managed by the Web server 103. However, the power management table and the upper limit of the power consumption may also be managed by a device other than the Web server 103. In this case, in the processing of operation S1202 of FIG. 11, the Web server 103 may generate screen information after receiving the power management table and the upper limit of the power consumption from the device different from the Web server 103.

Now, a third exemplary embodiment as a modified example of the first exemplary embodiment is described below.

In the first exemplary embodiment, the MFP 101 controls the Web browser 401 and the proxy unit 403 so that the MFP 101 does not execute the function corresponding to the Web application consuming the power beyond the upper limit of the power consumption.

To the contrary, in the second exemplary embodiment, the Web server 103 controls a transmission/non-transmission of the executive instruction of the Web application so that the MFP 101 does not execute the function corresponding to the Web application consuming the power beyond the upper limit of the power consumption.

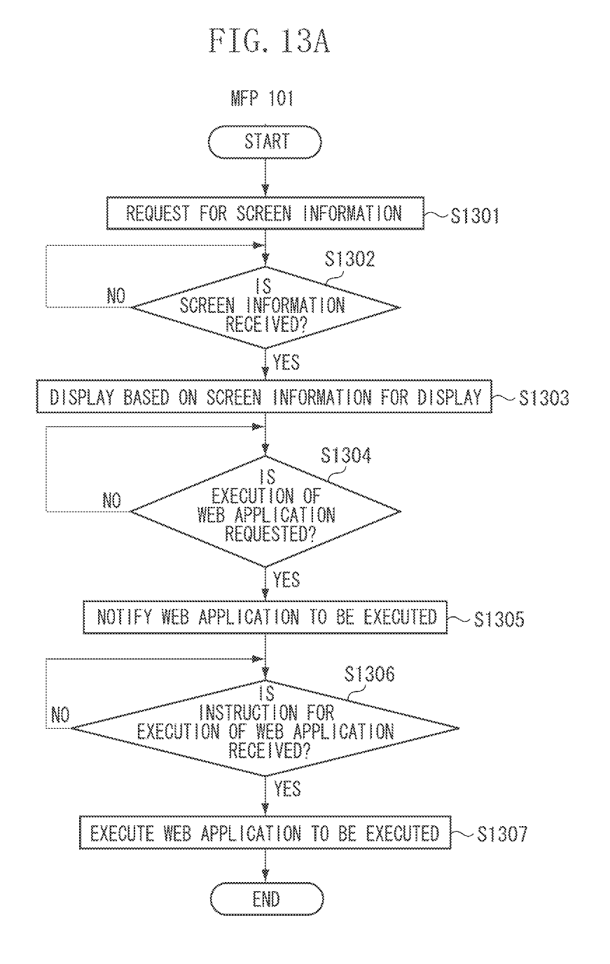

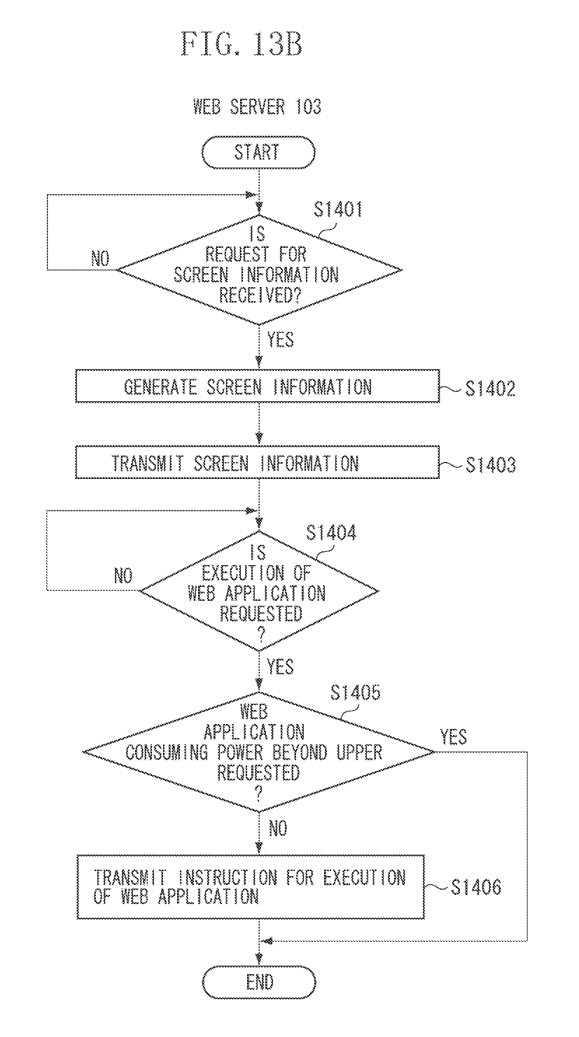

Processing operations performed when the MFP 101 requests screen information to the Web server 103 and displays the operation screen based on the screen information transmitted from the Web server 103 as required, are described below with reference to a flowchart of FIG. 13. In operations S1301 through 1307 in FIG. 13, the CPU 203 of the MFP 101 develops the programs stored in the ROM 204 and the HDD 210 on the RAM 205 to execute the programs. In operations S1401 through S1406 in FIG. 13, the CPU 302 of the Web server 103 develops the programs stored in the ROM 303 and the HDD 305 on the RAM 304 to execute the programs.

Processing performed in each of the operations S1301, S1302, and S1303 through S1307 of FIG. 13 is identical to the processing performed in each of the operations S701, S703, and S706 through S710 in the first exemplary embodiment, so that a description thereof is omitted. The processing executed by the MFP 101 in the third exemplary embodiment differs from the processing executed by the MFP 101 in the first exemplary embodiment in that the processing executed in each of the operations S702, S704, and S705 is not included.

Processing performed in each of the operations S1401 and S1402 through S1404 of FIG. 13 is identical to the processing performed in each of the operations S801 and S803 through S805 in the first exemplary embodiment, so that a description thereof is omitted. Processing performed in operation S1406 of FIG. 13 is identical to the processing performed in operation S806 in the first exemplary embodiment, so that a description thereof is omitted here.

Processing performed by the Web server 103 in the third exemplary embodiment differs from the processing performed by the Web server 103 in the first exemplary embodiment in that the processing performed in operation 802 is not included. The third exemplary embodiment differs from the first exemplary embodiment in that processing performed in operation S1405 by the Web server 103 in the third exemplary embodiment is not included in the processing performed by the Web server 103 in the first exemplary embodiment.

Now, processing executed by the Web server 103 in operation S1405 is described below.

In operation S1405, the Web server 103 determines whether or not the Web application having received the execution request is the Web application consuming the power beyond the upper limit of the power consumption. In a case where the Web server 103 determines that the Web application having received the execution request is the Web application consuming the power beyond the upper limit of the power consumption (YES in operation S1405), the Web application having received the execution request is not executed and the processing is ended. On the other hand, in a case where the Web server 103 determines that the Web application having received the execution request is not the Web application consuming the power beyond the upper limit of the power consumption (NO in operation S1405), in operation S1406, the executive instruction of the Web application having received the execution request is transmitted.

In FIG. 5, the power consumption of the image reading application is 100 W, the power consumption of the print application is 1000 W, and the power consumption of the reproduction application is 1100 W. In FIG. 6, the upper limit of the power consumption is 1050 W. In this case, in a case where the Web application having received the execution request is the image reading application, in operation S1406, the CPU 302 of the Web server 103 controls the Web browser 401 or the proxy unit 403 to transmit the executive instruction of the image reading application. In a case where the Web application having received the execution request is the print application, in operation S1406, the CPU 302 of the Web server 103 controls the Web browser 401 or the proxy unit 403 to transmit the executive instruction of the print application. In a case where the Web application having received the execution request is the reproduction application, the CPU 302 of the Web server 103 controls the Web browser 401 or the proxy unit 403 not to transmit the executive instruction of the Web application having received the execution request.

As described above, the third exemplary embodiment provides the information processing system including the Web server 103 and the MFP 101 with the Web browser 401 for displaying a screen based on the screen information provided by the Web server 103. According to the third exemplary embodiment, the MFP 101 sets the upper limit of the power consumed by executing at least anyone of the functions and maybe suitably controlled not to execute the function consuming the power beyond the set power.

In the above description, the power management table and the upper limit of the power consumption are managed by the Web server 103. However, the power management table and the upper limit of the power consumption may also be managed by a device different from the Web server 103. In this case, in the processing of operation S1202 of FIG. 11, the Web server 103 may generate the screen information after receiving the power management table and the upper limit of the power consumption from the device different from the Web server 103.

### Other Embodiments

Aspects of the embodiments may also be realized by a computer of a system or apparatus (or devices such as a CPU or MPU) that reads out and executes a program recorded on a memory device to perform the functions of the above-described embodiment(s), and by a method, the operations of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

Further, the present exemplary embodiment may also be realized by supplying software (e.g., a program or a set of instructions) for realizing the functions of the above exemplary embodiments to a system or an apparatus via a network or via various storage media, and having a computer (a central processing unit (CPU) or a micro processing unit (MPU)) of the system or apparatus read and execute the program or the instructions recorded/stored on an article of manufacture having a memory device or a non-transitory storage medium to perform operations or functions of the above-described embodiments. In this case, this program and the recording medium on which the program is recorded/stored constitute one disclosed aspect of the embodiments. In addition, the program may be executed by one computer, or by a plurality of computers linked together.

Disclosed aspects of the embodiments may be realized by an apparatus, a machine, a method, a process, or an article of manufacture that includes a non-transitory storage medium having a program or instructions that, when executed by a machine or a processor, cause the machine or processor to perform operations as described above. The method may be a computerized method to perform the operations with the use of a computer, a machine, a processor, or a programmable device. The operations in the method involve physical objects or entities representing a machine or a particular apparatus (e.g., an information processing apparatus, a Web server). In addition, the operations in the method transform the elements or parts from one state to another state. The transformation is particularized and focused on displaying a screen. The transformation provides a different function or use such as requesting a transmission, displaying a screen, executing the function, etc.

In addition, elements of one embodiment may be implemented by hardware, firmware, software or any combination thereof. The term hardware generally refers to an element having a physical structure such as electronic, electromagnetic, optical, electro-optical, mechanical, electro-mechanical parts, etc. A hardware implementation may include analog or digital circuits, devices, processors, applications specific integrated circuits (ASICs), programmable logic devices (PLDs), field programmable gate arrays (FPGAs), or any optical, electromechanical, electromagnetic, or electronic devices. The term software generally refers to a logical structure, a method, a procedure, a program, a routine, a process, an algorithm, a formula, a function, an expression, etc. A software implementation typically includes realizing the above elements (e.g., logical structure, method, procedure, program) as instruction codes and/or data elements embedded in one or more storage devices and executable and/or accessible by a processor, a CPU/MPU, or a programmable device as discussed above. The term firmware generally refers to a logical structure, a method, a procedure, a program, a routine, a process, an algorithm, a formula, a function, an expression, etc., that is implemented or embodied in a hardware structure (e.g., flash memory). Examples of firmware may include microcode, writable control store, micro-programmed structure. When implemented in software or firmware, the elements of an embodiment may be the code segments to perform the necessary tasks. The software/firmware may include the actual code to carry out the operations described in one embodiment, or code that emulates or simulates the operations.

All or part of an embodiment may be implemented by various means depending on applications according to particular features, functions. These means may include hardware, software, or firmware, or any combination thereof. A hardware, software, or firmware element may have several modules or units coupled to one another. A hardware module/unit is coupled to another module/unit by mechanical, electrical, optical, electromagnetic or any physical connections. A software module/unit is coupled to another module by a function, procedure, method, subprogram, or subroutine call, a jump, a link, a parameter, variable, and argument passing, a function return, etc. A software module/unit is coupled to another module/unit to receive variables, parameters, arguments, pointers, etc. and/or to generate or pass results, updated variables, pointers, etc. A firmware module/unit is coupled to another module/unit by any combination of hardware and software coupling methods above. A hardware, software, or firmware module/unit may be coupled to any one of another hardware, software, or firmware module/unit. A module/unit may also be a software driver or interface to interact with the operating system running on the platform. A module/unit may also be a hardware driver to configure, set up, initialize, send and receive data to and from a hardware device. An apparatus may include any combination of hardware, software, and firmware modules/units.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-268748 filed Dec. 1, 2010, which is hereby incorporated by reference herein in its entirety.

What is claimed is:

1. An information processing system including a Web server and an information processing apparatus with a Web browser for displaying a screen based on screen information transmitted from the Web server:
wherein the information processing apparatus comprises:
a first requesting unit configured to request a transmission of the screen information for allowing the Web browser to display a screen, to the Web server;
a first receiving unit configured to receive the screen information transmitted from the Web server in response to the request of the first requesting unit;
a Web browser configured to display the screen based on the screen information received by the first receiving unit;
a reception unit configured to receive a request of an executive instruction input from an operator via an area, in a case where an area for requesting to the Web server an executive instruction of a Web application related to at least any one of functions executable by the information processing apparatus is included in the screen displayed by the Web browser;
a second requesting unit configured to request the executive instruction of the Web application to the Web server, in a case where the reception unit receives the request of the executive instruction; and
an execution unit configured to execute the function in response to the reception of the executive instruction of the function related to the Web application from the Web server;
wherein the Web server comprises:
a first transmission unit configured to transmit, in a case where a transmission of the screen information is requested by the first requesting unit, the screen information to the information processing apparatus; and
a second transmission unit configured to transmit the executive instruction of the function related to the Web application corresponding to the request, to the information processing apparatus, in a case where the executive instruction of the Web application is requested by the second requesting unit; and
wherein the information processing system further comprises:
a storage unit configured to store information indicative of a power consumed when executing the function with respect to each of the plurality of functions;
a setting unit configured to set an upper limit of the power consumed when executing at least any one of the functions by the information processing apparatus;
a determination unit configured to determine whether or not the power consumed by the execution of the function exceeds the power set by the setting unit with respect to each of the functions based on the information stored in the storage unit; and
a control unit configured to perform control such that the function determined by the determination unit as consuming the power beyond the power set by the setting unit is not executed by the execution unit.

2. The information processing system according to claim 1, wherein the control unit controls the Web browser such that the area for requesting the executive instruction of the Web application related to the function determined by the determination unit as consuming the power beyond the set power to the Web server is not displayed on the screen.

3. The information processing system according to claim 1, wherein the control unit controls the second requesting unit not to request the executive instruction of the Web application related to the function determined by the determination unit as consuming the power beyond the set power to the Web server.

4. The information processing system according to claim 1, wherein the Web server comprises:
a generating unit configured to generate the screen information;
wherein the control unit controls the generating unit to generate screen information which excludes the area for requesting the executive instruction of the Web application related to the function determined by the determination unit as consuming the power beyond the set power and includes the area for requesting the executive instruction of the Web application related to the function determined by the determination unit as not consuming the power beyond the set power.

5. The information processing system according to claim 1, wherein the control unit controls the second transmission unit not to transmit the executive instruction of the function related to the Web application, to the information processing apparatus in a case where the function related to the Web application is determined by the determination unit as consuming the power beyond the set power even if the executive instruction of the Web application is requested by the second requesting unit.

6. The information processing system according to any one of claim 1:
wherein the information processing apparatus comprises:
an image reading unit configured to execute image reading processing for reading a document to generate image data; and
a print unit configured to execute print processing for printing an image on a sheet based on the image data;
wherein the plurality of functions include a function of executing the image reading processing and a function of executing the print processing.

7. The information processing system according to claim 6, wherein the plurality of functions include a reproducing function for executing the image reading processing as well as subjecting the image data generated in the image reading processing to the print processing by the print unit.

8. A method for displaying a screen based on screen information transmitted from a Web server, comprising:
requesting a transmission of the screen information for allowing a Web browser to display a screen based on the screen information, to the Web server;
receiving the screen information transmitted from the Web server in response to the request of the first requesting unit;
receiving a request of an executive instruction input from an operator via an area, in a case where an area for requesting to the Web server an executive instruction of a Web application related to at least any one of functions executable by an information processing apparatus is included in the screen displayed by the Web browser;
requesting the executive instruction of the Web application to the Web server, in a case where the request of the executive instruction is received;
executing the function in response to receiving the executive instruction of the function related to the Web application from the Web server;
transmitting, in a case where a transmission of the screen information is requested, the screen information;
transmitting the executive instruction of the function related to the Web application, to the information processing apparatus, in a case where the executive instruction of the Web application is requested;
storing information indicative of a power consumed when executing the function with respect to each of the plurality of functions;
setting an upper limit of the power consumed when executing at least any one of the functions by the information processing apparatus;
determining whether or not the power consumed by the execution of the function exceeds the set power with respect to each of the functions based on the stored information; and
performing control such that the function determined as consuming the power beyond the set power is not executed by the execution unit.

9. A computer-readable storage medium having instructions that, when executed by a processor, cause the processor to perform operations for displaying a screen based on screen information transmitted from a Web server, the operations comprising:
requesting a transmission of the screen information for allowing a Web browser to display a screen based on the screen information, to the Web server;
receiving the screen information transmitted from the Web server in response to the request of the first requesting unit;
receiving a request of an executive instruction input from an operator via an area, in a case where an area for requesting to the Web server an executive instruction of a Web application related to at least any one of functions executable by an information processing apparatus is included in the screen displayed by the Web browser;
requesting the executive instruction of the Web application to the Web server, in a case where the request of the executive instruction is received;
executing the function in response to receiving the executive instruction of the function related to the Web application from the Web server;
transmitting, in a case where a transmission of the screen information is requested, the screen information;
transmitting the executive instruction of the function related to the Web application, to the information processing apparatus, in a case where the executive instruction of the Web application is requested;
storing information indicative of a power consumed when executing the function with respect to each of the plurality of functions;
setting an upper limit of the power consumed when executing at least any one of the functions by the information processing apparatus;
determining whether or not the power consumed by the execution of the function exceeds the set power with respect to each of the functions based on the stored information; and
performing control such that the function determined as consuming the power beyond the set power is not executed by the execution unit.
